(19) United States
(12) Patent Application Publication
(10) Pub. No.: US 2023/0401395 A1
(43) Pub. Date: Dec. 14, 2023

(54) METHOD AND SYSTEM FOR RFID INTERROGATION

(71) Applicant: Shopify Inc., Ottawa (CA)

(72) Inventors: Daanish Maan, Brampton (CA); Michael Joseph DeFazio, Fonthill (CA)

(21) Appl. No.: 17/835,249

(22) Filed: Jun. 8, 2022

(51) Int. Cl. G06K 7/10; G06K 7/00; G06K 19/07

(52) U.S. Cl. CPC G06K 7/10366; G06K 7/0008; G06K 19/0723

(57) ABSTRACT

A method at a computing system including starting a scan of a region using an interrogator, the region including more than one area to be scanned; detecting an object exists within an area of the region; and performing the scan of the region while avoiding scanning the area in which the object exists.

### FIELD OF THE DISCLOSURE

The present disclosure is related to radio frequency interrogation, and in particular relates to selective radio frequency interrogation.

### BACKGROUND

Radio Frequency Identification (RFID) can be used in a variety of situations. One potential area of use involves the tracking or locating of inventory within a location, such as a store. This involves affixing tags onto each item of inventory, where such tags may be scanned by an interrogator.

An interrogator could be a device with a transmitter for sending a signal that is used to power up passive RFID tags and a receiver to receive signals back from such passive RFID tags. In other cases, the interrogator could have a transmitter to send a signal to an active RFID tag, which may provide its own power to send a response to a receiver in the interrogator.

Interrogators may take various forms. In some embodiments, an interrogator can be part of a fixed infrastructure that is used to read from tags within a particular area. For example, a fixed interrogator may involve an archway around an entrance to a facility or may involve a network of interrogators within a facility to send signals to the areas where tags may be, among other options. In other embodiments, interrogators may be handheld and may be used by an employee of the facility. In other embodiments, the interrogators may be part of a robotic system, where one or more robots may move among the locations scanning tags. Other options for interrogators are possible.

### SUMMARY

Merchants can use one or more RFID interrogators and RFID tags to track inventory in a space. However, objects passing through the space may attenuate RFID signals and cause inventory counts to become inaccurate. Further, the continual use of interrogators may expose employees and/or customers that are proximate to such interrogators to significant amounts of electromagnetic waves, which may in some jurisdictions be contrary to health guidelines.

Therefore, in one aspect, a method at a computing system may be provided, where the method may include starting a scan of a region using an interrogator, the region including more than one area to be scanned. The method may further include detecting that an object exists within an area of the region. The method may further include performing the scan of the region while avoiding scanning the area in which the object exists.

In some embodiments, the object may be a person within the scan area.

In some embodiments, the avoiding may comprise cancelling the scan.

In some embodiments, the avoiding may comprise disabling the interrogator when the interrogator is pointed at the object.

In some embodiments, the avoiding may comprise applying radio directionality to the interrogator to avoid the object.

In some embodiments, the detecting that the object exists within the area of the region may comprise identifying the object as a particular person, finding a history of exposure by the person to scans by one or more interrogators, and determining that the exposure by the particular person within a timeframe exceeds a threshold.

In some embodiments, the method may further comprise scheduling a later scan of the area which was avoided.

In some embodiments, the scheduling the later scan may comprise waiting until the object moves from the area which scanning was avoided.

In some embodiments, the scheduling the later scan may comprise directing the interrogator to be moved back to the area in which scanning was avoided.

In some embodiments, the scan may be a scan for Radio Frequency Identification (RFID) devices and the interrogator may be a RFID interrogator for inventory control.

In a further aspect, a computing system having at least one interrogator, a processor and a communications subsystem may be provided. The computing system may be configured to start a scan of a region using the at least one interrogator, the region including more than one area to be scanned. The computing system may further be configured to detect an object exists within an area of the region and perform the scan of the region while avoiding scanning the area in which the object exists.

In some embodiments, the object may be a person within the scan area.

In some embodiments, the avoiding may comprise cancelling the scan.

In some embodiments, the avoiding may comprise disabling the interrogator when the interrogator is pointed at the object.

In some embodiments, the avoiding may comprise applying radio directionality to the interrogator to avoid scanning the object.

In some embodiments, the computing system may be configured to detect that the object exists within the area of the region by identifying the object as a particular person; finding a history of exposure by the person to scans by one or more interrogators; and determining that the exposure by the particular person within a timeframe exceeds a threshold.

In some embodiments, the computing system may further be configured to schedule a later scan of the area which was avoided.

In some embodiments, the computing system may be configured to schedule the later scan by waiting until the object moves from the area which scanning was avoided.

In some embodiments the computing system may be configured to schedule the later scan by directing the interrogator to be moved back to the area in which scanning was avoided.

In some embodiments, the scan may be a scan for Radio Frequency Identification (RFID) devices and the interrogator may be a RFID interrogator for inventory control.

In another aspect, a computer-readable medium for storing instruction code may be provided. The instruction code, when executed by a processor of a computing system having at least one interrogator, may cause the computing system to start a scan of a region using the at least one interrogator, the region including more than one area to be scanned. The instruction code, when executed by the processor may further cause the computing system to detect an object exists within an area of the region and perform the scan of the region while avoiding scanning the area in which the object exists.

### BRIEF DESCRIPTION OF THE DRAWINGS

The present disclosure will be better understood with reference to the drawings, in which:

FIG. 1 is a block diagram showing an example computer system capable of being used with the embodiments of the present disclosure.

FIG. 2 is a block diagram showing a further example computer system capable of being used with the embodiments of the present disclosure.

FIG. 3 is a process diagram showing a method for avoiding an area during interrogation.

FIG. 4 is a dataflow diagram showing communications between two computer systems during interrogation.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art.

In accordance with the embodiments of the present disclosure, a computer system associated with one or more interrogators, such as an RFID interrogator, may utilize information from sensors (secondary sensors) outside of the interrogator to detect that an object is within a space that the interrogator will be sending signals to. Such object may cause inaccurate results to be received based on the interrogation, and may further expose the object to electromagnetic waves, which may in some cases be undesirable.

Based on or responsive to the detection of the object in the area in which an interrogation is set to occur, the computer system could cause the interrogator to avoid scanning the area with the object. This could involve various techniques, including disabling the interrogator temporarily, disabling the interrogator while it is pointed towards the object, applying radio directionality to the interrogator to avoid scanning the object, among other options.

In accordance with the embodiments of the present disclosure, various interrogators could be utilized. In one example, a plurality of interrogators may be distributed in fixed locations within a facility. In one example, at least one interrogator may be handheld or affixed to a mobile platform and be operated by an employee of the facility. In one example, at least one interrogator may be affixed to a robotic base and may be moved within the facility. In one example, a combination of fixed and mobile interrogators may be used. The above examples are however not limiting and in other cases other forms of interrogators could be used.

In the examples below, interrogators are used for inventory control within a store or warehouse. In these examples, tags may be affixed to inventory. For example, the tags may be passive or active radio frequency identification (RFID) tags that could be affixed to the inventory. The interrogator in this case could be an RFID interrogator that is capable of emitting a radio frequency signal using a transmitter, and receiving information from the one or more tags affixed to the inventory using a receiver. The use of the methods and systems of the present disclosure for inventory control is however merely provided for illustration purposes, and other use cases are possible.

Computer System

Interrogators may be part of a computing system in which the computing system controls the sending of signals from the interrogator and the interpretation of the results received by a receiver within the interrogator. One example of such system would be a store or warehouse in which fixed interrogators may be distributed throughout the store, for example mounted to walls, ceilings, shelving units, or other such surfaces. The computing system may have additional sensors associated with it. For example, one or more interrogators may be associated with a computing system that has access to sensors such as a camera, a positional sensor such as an IR sensor, lasers, pressure sensors, accelerometers, short range communication modules, among other options.

In other cases, an interrogator may be connected via wired or wireless means to a server or computing device.

In other cases, interrogators may be mobile interrogators that have sensors associated therewith. For example, a handheld interrogator may include other sensors that can be used to detect objects within the scanning area. Similarly, a robotic interrogator may include sensors that can be used to detect objects within the scanning area.

In other cases, the interrogator may be associated with a first computing device such as a handheld scanner which can be in communication with the second computing device, such as a server controlling interrogation or inventory control, for example.

In other cases, a short-range communications module may consist merely of a reader and other sensors may be associated with another computing device.

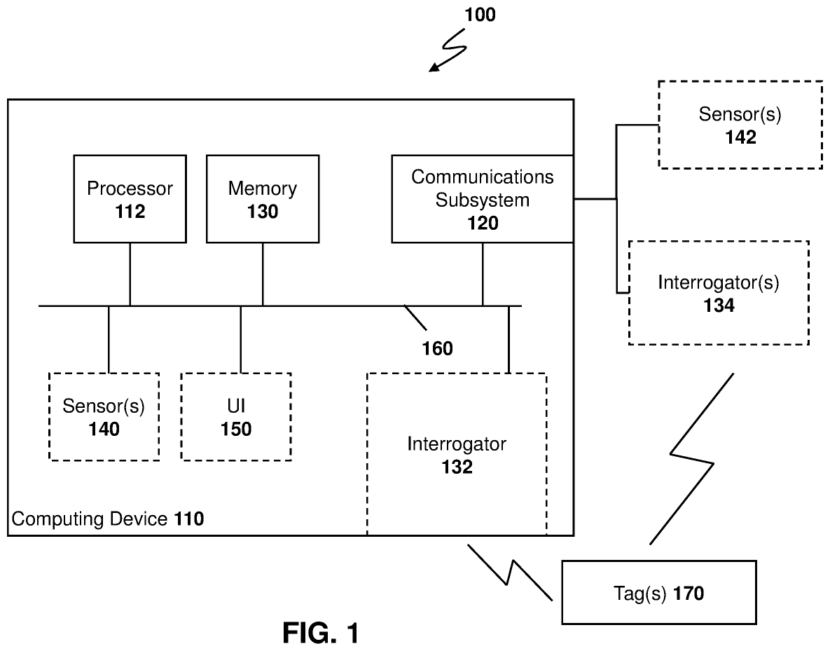

Therefore, reference is now made to FIG. 1, which shows an example, simplified, computing system 100. In the example of FIG. 1, a computing device 110 may include a processor 112 and a communications subsystem 120, where the processor 112 and the communications subsystem 120 cooperate to perform the methods of the embodiments described herein.

Processor 112 is a hardware processor configured to execute programmable logic, which may be stored, along with data, on computing device 110 and shown in the example of FIG. 1 as memory 130. Memory 130 can be any tangible, non-transitory computer readable storage medium such as optical (e.g., CD, DVD, etc.), magnetic (e.g., tape), flash drive, hard drive, or other memory known in the art.

Alternatively, or in addition to memory 120, computing device 110 may access data or programmable logic from an external storage medium, for example through communications subsystem 120.

Communications subsystem 120 allows computing device 110 to communicate with other devices or network elements and the design of communications subsystem 120 may be based on various types of communications being performed. Further, communications subsystem 120 may comprise a plurality of communication technologies, including any wired or wireless communication technology.

In the embodiment of FIG. 1, computing device 110 may include an interrogator 132. Interrogator 132 generally consists of at least a transceiver subsystem having a transmitter and a receiver. In operation, interrogator 132 sends an activation signal having predetermined frequencies. Active or passive tags such as tag 170 would receive the activation signal and provide a response back to the interrogator. In the case of the passive tag, the signal from the interrogator 132 powers the circuit to allow the provision of the response. In the case of an active tag, the tag could be powered by the power source at the tag, and this would allow various options such as multiple responses to a single interrogation activation signal, among other options. Thus, the present disclosure allows a single request, single response model of interrogation; a multiple request, multiple response model of interrogation; a single request, multiple response model of interrogation, among other options.

In the example of FIG. 1, interrogator 132 is internal to computing device 110. However, in other embodiments, the interrogator may be external to the computing device 110. For example, in the case that the interrogator is external, it may communicate through communications subsystem 120. This is shown in the embodiment of FIG. 1 as interrogator 134. For example, a plurality of fixed interrogators 134 may be located around a facility, and communicate with the computing system through communications subsystem 120. In certain circumstances, a combination of internal and external interrogators may also be used with computing device 110 within computer system 100.

Further, other sensors may be associated with the computing device 110. Such sensors may be internal sensors, shown as sensors 140 in the embodiment of FIG. 1. In other cases, the sensors may be external and are shown as sensors 142 in the embodiment of FIG. 1. In certain circumstances, a combination of internal and external sensors may also be used with computing device 110 within computer system 100.

Sensors 140 or 142 may consist of various sensors that can be used to analyse whether an object is in the area that is to be scanned. For example, in some cases, the sensors may comprise cameras or other image capture modules. In other cases, sensors may include proximity modules such as an IR detector, RADAR, LIDAR, among others. In still other situations, the sensors may include motion sensors such as passive infrared (PIR), microwave, ultrasonic, tomographic motion detectors, among other options. In other cases, the sensors can include bump sensors such as accelerometers, pressure sensors, among others. In other cases, the sensors can include beam trip sensors such as lasers across the entrance and exits to an aisle. In various circumstances, a plurality of sensors may exist and be associated with the computing system. Thus, a combination of the various types of sensors may be available within the computing system.

In the embodiment of FIG. 1, computing device 110 further includes a user interface (UI) 150. The user interface 150 can be any auditory, visual or haptic feedback mechanism to provide a user with information. For example, user interface 150 could be a display screen, light, speaker, vibration mechanism, among other options.

Communications between the various modules within a computing device can be done in a variety of ways. In the example of FIG. 1, a bus 160 is shown to allow communications between the various modules. However, this is merely provided for illustration purposes and other types of communication between modules is possible.

In operation, a tag 170 may be activated by interrogator(s) 132 or 134 in order to have information stored on, or derived by, tag 170 transmitted to the interrogator(s) 132 or 134. For example, tag 170 may be affixed to a particular piece of inventory within a facility. An inventory control operation may involve activating all of the tags on a shelf or in an area and receiving information from these tags at the interrogator in order to determine which tags are present. If each tag has a unique identifier that is associated with a particular item, then inventory control can happen quickly without manually requiring staff to perform inventory counts.

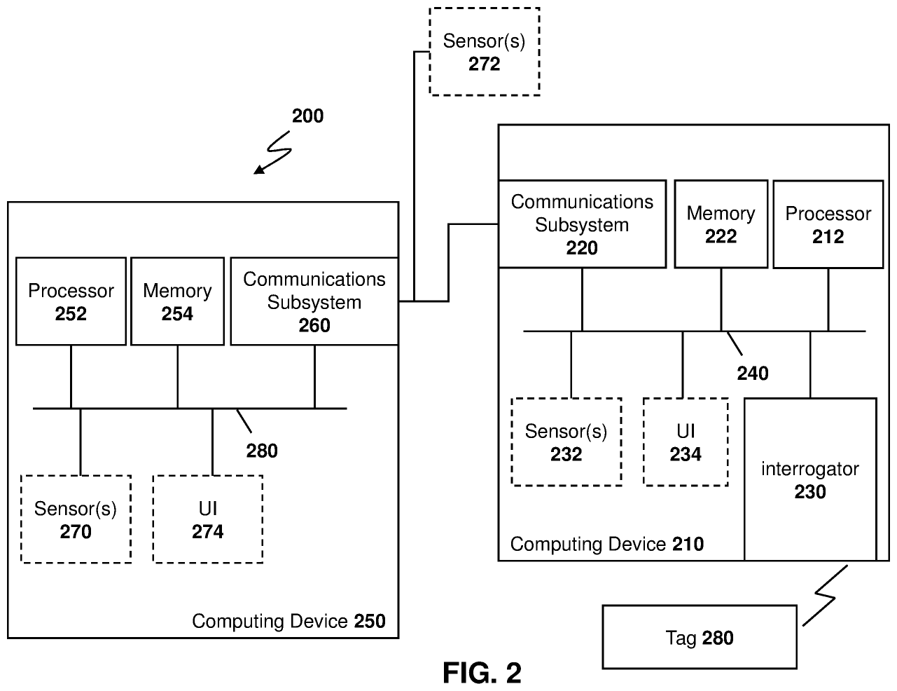

While the embodiment of FIG. 1 shows a single computing device with internal or external sensors and/or internal or external interrogators, in other cases, a plurality of computing devices may exist within a computer system. Reference is now made to FIG. 2.

In the example of FIG. 2, a simplified computing system 200 having a first computing device 210 and a second computing device 250 is shown. In particular a computing device 210 may be associated with an interrogator and be similar to computing device 110 from FIG. 1. Computing device 210 includes a processor 212 and a communications subsystem 220, where the processor 212 and the communications subsystem 220 cooperate to perform the methods of the embodiments described herein.

Processor 212 is a hardware processor configured to execute programmable logic, which may be stored, along with data, on computing device 210 and shown in the example of FIG. 2 as memory 222. Memory 222 can be any tangible, non-transitory computer readable storage medium such as optical (e.g., CD, DVD, etc.), magnetic (e.g., tape), flash drive, hard drive, or other memory known in the art.

Alternatively, or in addition to memory 222, computing device 210 may access data or programmable logic from an external storage medium, for example through communications subsystem 220.

Communications subsystem 220 allows computing device 210 to communicate with other devices or network elements and the design of communications subsystem 220 may be based on various types of communications being performed. Further, communications subsystem 220 may comprise a plurality of communication technologies, including any wired or wireless communication technology.

In the embodiment of FIG. 2, computing device 220 may have an interrogator 230. For example, this may consist of an RFID reader. In the example of FIG. 2, interrogator 230 is internal to computing device 210. However, in other embodiments, the interrogator may be external to the computing device 210.

Further, other sensors may be associated with the computing device 210. Such sensors may be internal sensors, shown as sensors 232 in the embodiment of FIG. 2. In other cases, the sensors may be external to the computing device. In certain circumstances, a combination of internal and external sensors may also be used with computing device 210.

Sensors 232 may consist of various sensors that can be used to analyse whether an object exists in a scan area. For example, in some cases, the sensors may comprise cameras or other image capture modules. In other cases, sensors may include proximity modules such as an IR detector, RADAR, LIDAR, among others. In still other situations, the sensors may include motion sensors such as passive infrared (PIR), microwave, ultrasonic, tomographic motion detectors, gesture detectors, among other options. In various circumstances, a plurality of sensors may exist and be associated with the computing system. Thus, a combination of the various types of sensors may be available within the computing system.

In the embodiment of FIG. 2, computing device 210 further may include a user interface (UI) 234. The user interface 234 can be any auditory, visual or a haptic feedback mechanism to provide a user with information. For example, user interface 234 could be a display screen, light, speaker, vibration mechanism, among other options. However, in some cases, user interface 234 is optional.

Communications between the various modules within computing device can be done in a plurality of ways. In the example of FIG. 2, a bus 240 is shown to allow communications between the various modules. However, this is merely provided for illustration purposes and other types of communication between modules is possible.

Further, in the embodiment of FIG. 2, a second computing device 250 is provided. Computing device 250 may be an external computing device that is associated with the computing device 210. For example, computing device 250 may be a computing device for an operator, including a mobile device or tablet that is associated with a handheld or robotic computing device 210 that includes interrogator 230. In other examples, computing device 250 may be a network server that is used to perform the processing or is provided as a backend for a particular computing system. For example, in some cases, computing device 250 may be used to perform image processing. In other cases, computing device 250 may be an inventory management system computing device associated with a particular store, group of stores, warehouse(s), or facilities. Other examples are possible.

As with computing device 210, computing device 250 may include a processor 252 and a communications subsystem 260, where the processor 252 and communications subsystem 260 cooperate to perform the methods of the present disclosure.

Processor 252 may use programmable logic to execute instructions stored in a memory 254. Further memory 254 may store other data and may be any non-transitory computer storage medium.

In some embodiments, computing device may have access to sensors 270 or 272, where such sensors may be similar to sensors 140 or sensors 142 from the embodiment of FIG. 1.

Further, in some cases computing device 250 may include a user interface 274 which may be used to provide visual, auditory or haptic feedback to a user of computing device 250. In this case, the user of computing device 250 may be different from the user operating the interrogator. For example, in some cases the user of computing device 250 may be store management, a head office staff member, franchisor, among other options, that may receive information from one or more interrogators. Other examples are possible.

In the embodiment of FIG. 2, communications between various modules are provided using bus 280. Again, communications between modules can be done in a variety of ways and this is merely provided for illustration.

Communications between computing device 210 and computing device 250 may occur through various mechanisms. For example, communications subsystem 220 may communicate with communications subsystem 260 through a wired or wireless connection such as ethernet, Bluetooth, Wi-Fi, USB, other serial port, among others. In other cases, communications subsystem 220 may communicate through a network such as, for example, the Internet, among other similar options, with communications subsystem 260. In this case, each of communications subsystems 220 and 260 may use wired or wireless communications to communicate with a router which may then route the communications over such a network. Such communications may include but are not limited to cellular, satellite, Wi-Fi, among others.

In operation, a tag 280 such as an RFID tag may be activated by interrogator 230 in order to have information stored on, or derived by, tag 280 transmitted to the interrogator 230. Tag 280 may be any of the tags described with regards to tag 170 of FIG. 1.

Therefore, in one example transaction, if computing device 210 is a handheld RFID reader, this computing device 210 may be moved around a store and scan tags. Such tags may be associated with items on store shelves, with the shelves themselves, among other options. A screen associated with user interface 234 may indicate to an operator that scanning is successfully occurring. Further, as described below, the UI 234 may direct the operator to scan a particular area of the store if rescanning, for example, is required.

Computing device at 210 may provide results of the scanning to computing device 250 in order to allow a computing device 250 to perform inventory control with the one or more interrogators. Further, communications between computing device 210 and computing device 250 could allow computing device 250 to direct where the computing device 210 is to perform scanning, whether certain areas should avoid being scanned, among other options.

Avoiding Objects During Scanning

As described above, during scanning, objects passing through the space may attenuate RFID signals and cause inventory counts to become inaccurate. Further, the continual use of interrogators may expose employees and/or customers that are proximate to such interrogators to significant amounts of electromagnetic waves, which may in some jurisdictions be contrary to health guidelines

While taking inventory during off hours, such as overnight, is possible, in some scenarios a closer to real-time inventory may be desirable.

Therefore, utilizing a computer system such as those described above with regard to FIGS. 1 and 2, the present disclosure provides for methods and systems to start scanning a region in which multiple areas need to be scanned, use secondary sensors to determine whether a person or any object that is unusually absorbent or reflective of the relevant radio frequencies is proximate an area that is going to be scanned by an interrogator, and delaying or avoiding the interrogation of the area. In some cases, the methods and systems may include rescheduling the interrogation of the affected area at a subsequent time.

Each is described below.

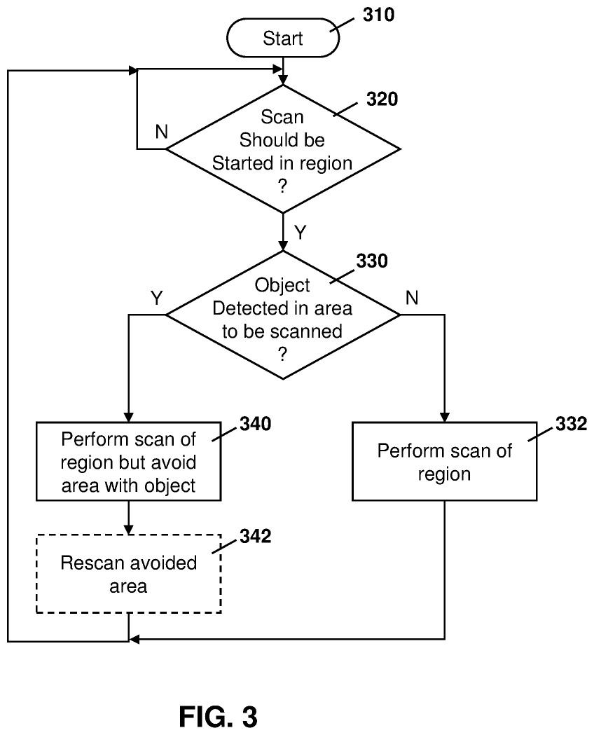

Reference is now made to FIG. 3. In the embodiment of FIG. 3 the process starts at block 310 and proceeds to block 320 in which a check is made to determine whether a scan should be performed in a particular region. As used herein, a region indicates an area such as a facility or a portion thereof. For example, in the inventory control case, the region may be the entire warehouse or store. In other cases, the region may be the sporting goods section of the store, the automotive section of the store, the frozen food aisle, among other regions.

The particular region that needs to be scanned includes a number of areas that need to be scanned. Such areas could include specific shelving units, specific shelves, specific aisles, among other such areas.

The check at block 320 could be based on a trigger event in some embodiments.

In some cases, a trigger may be a time based event. For example, a scan may occur every 15 minutes.

In other cases, the trigger may be an on-demand trigger based on the needs of a business. Thus, a manager could manually start a scan to check inventory, for example.

In some cases, the trigger may be automatically set. For example, timing of the trigger may be optimized for business hours or optimized for traffic patterns and manual adjustments. The computing system may learn, via sensors such as cameras, optimal times to run a scan. Thus, a machine learning model may be used to schedule the trigger in some cases.

In some cases, the trigger could be an activity trigger. For example, the trigger may be a product movement trigger, where, if one or more people are detected to be in an aisle and are moving products, putting products in their shopping cart, restocking product back on shelves, among other options, this could trigger an inventory count. In some cases, the trigger may be after such person has moved away from the area.

In some cases, an activity trigger could be based on staff making adjustments to or restocking certain areas.

In some cases, an activity trigger could be based on a request for customer assistance in a particular area or region. For example, if a customer is looking for a product with low stock which is not in a designated location, a scan could be initiated for the product in a wider area to find whether the product was moved or misplaced.

In some cases, an activity based trigger could be based on merchandising, which may involve moving products around for sales and displays.

In some cases, time based triggers and activity based triggers could both be part of a system.

Activity based triggers may, for example, be determined utilizing sensors such as sensors 140, 142, 270, or 272 from FIGS. 1 and 2. For example, a camera in a facility may be recording a particular area. Such recorded information may be provided back to the computing system, where image processing could be used to determine if particular actions are occurring. For example, such actions may include products being moved, products being put into carts with no sales being recorded for such product, products being placed on shelves, a threshold number of people having interacted with a shelving unit, if employees are detected, among other options.

In some cases, short range communications sensors could detect the presence of an employee within a particular area of the store based on a mobile device carried by such employee. This may indicate that a restocking or merchandising action has occurred, and a trigger condition may therefore be met.

In other cases, a laser or pressure sensor or motion sensor may detect foot traffic in an aisle and if a threshold number of people have been through the aisle this may trigger a scan of such aisle.

In other cases, the trigger may be based on an inventory system and/or a sales system indicating that a number of remaining products of a certain type has reached a threshold. For example, if a particular product had a certain number of sales of such product, this may indicate that stock is running low and may cause a trigger event to see how many of the product are left at a designated location. If the number of remaining items of that product is below an anticipated amount, this may trigger a wider scan to see if the product was moved, for example by a customer or employee, to a different area of the facility.

Other options for a trigger are possible.

From block 320, if the scan should not be started for the region, the process proceeds back to block 320 to continue to wait until the condition for scanning a region is met.

Once the determination at block 320 to start a scan has been made, the process proceeds from block 320 to block 330 in which a check is made to determine whether any object is detected in the area that is to be scanned

In some embodiments, secondary sensors can be used to detect whether an object is within the scanning area for an RFID interrogator. In one case, such secondary sensors could include cameras which could monitor in an area, monitor ingress or egress from an area, among other options. In this case, image processing may be used to identify the object.

In other cases, the secondary sensors could include thermal sensors, pressure sensors, proximity sensors, among other options. For example, a laser could be placed across the entrance and exit to an aisle and a count could be made to determine whether anyone is in that aisle. In other cases, a pressure sensor could be employed at the entrance and exit to an aisle or other location.

In other cases, the secondary sensors could include badges or tokens associated with employees of the location. For example, short range communications could indicate that an employee has entered an area. This could include badges with RFID tags built into them, beacon signals from mobile devices carried by the employee, among other options.

In some cases, the secondary sensors may be associated with the interrogation device itself. For example, a camera on the interrogation device may be used to detect the presence of an object. Motion sensors, LIDAR, Radar, infrared, among other sensors could also be used on such interrogation device.

In other cases, the secondary sensors could be located within the area such as overhead cameras among other options.

Thus, at block 330, a check is made to determine whether any object is detected in the area to be scanned. Such object may be a person, including a customer or an employee, as well as items that may have been placed in a location. For example, a pallet of goods or products may have been placed behind a shelving unit and may cause issues for the scanning of products on this shelving unit.

If no object is detected, the process proceeds from block 330 to block 332 in which a scan of the region may be performed as normal. From block 332, the process proceeds back to block 320 to determine whether a scan should be started again for the region.

Conversely, if an object is detected in the area to be scanned, the process proceeds to block 340 in which a scan may be performed of the region, but avoiding the area with the object.

Specifically, if a person or an object is detected in the scan area for an interrogator, the scanning may be limited in some cases. This may involve, for example, blocking scanning from taking place from the interrogator.

Specifically, if the interrogator is a fixed interrogator, then scanning may simply not occur from such an interrogator until the object moves. This may be controlled by computer system 100.

If the interrogator is a mobile interrogator, such as one operated by an employee or a robot, then scanning may be interrupted while the interrogator is pointed in the direction of the object. In some cases, the interrogator may have secondary sensors to detect when the scanning direction is getting close to pointing at the object in order to turn off the interrogator. For example, a camera on a handheld reader could be used to make a determination that the scanning beam from the interrogator is being moved close to the object, and turn off the scanning based on this determination.

In other cases, positional and/or directional sensors on the handheld interrogator may be used to determine when the scanner is about to scan the object.

In other cases, communication with a server or computing system that has access to sensors such as camera sensors may cause the handheld interrogator to stop scanning at a particular point in time when such interrogator is getting close to being pointed towards the detected object. Other options are possible.

In some cases, scanning may be limited by restricting the area that the scan occurs in. For example, beamforming, a directional antenna, a parabolic antenna, a back shielding around/behind antenna, a rotating mount, or other techniques for limiting the direction of the scan may be employed to avoid scanning the object. Such techniques may be referred to herein as “radio directionality”. Such radio directionality may be used for both fixed and portable interrogators.

In some cases, if the person can be identified, scanning may still be allowed up to a particular limit. For example, an employee may be allowed to be within the field of an RFID scan up to a certain threshold number of times each day or each month. In this case, the limiting of the area being scanned may be determined by whether the employee has met that threshold or not.

Thus, for example, an employee may be identified based on their employee badge, a mobile device carried by the employee, facial recognition among other options. The computing system 100 may track the number of times that such employee has been in the scanning region of an interrogator and may make a decision on whether the employee would be considered an object within the scan area. Specifically, if an employee is allowed to be within a scan area up to five times a day, the computing system would not consider the employee to be an object within the scan area for the first five scans. After this, the computing system 100 would consider the employee to be an object within the scan area and would avoid scanning the area with the employee.

In some cases, scanning may occur regardless of whether an object exists within the scan area. However, the computing system may need to still know that an object was in the area since this may interfere with true readings.

From block 340, the process may proceed optionally to block 342 in which the area which was avoided for scanning may be rescanned or maybe scheduled to be scanned.

Specifically, whether the scan occurred or not, the computing system may need to know the affected area in which the scan was either limited or compromised. This information may be used to schedule scanning of such area in the future.

In some cases, the scanning may be rescheduled based on the detection of the object. For example, with a fixed network of interrogators, the scanning may be delayed in a particular area until the object/person has moved out of the area, at which point scanning may occur.

For mobile scanning, the rescheduling may involve directing the robot or the employee back to a particular area to perform another scan. This may involve route planning to best use the robot or employee's time. Signalling between the computing device and the handheld or robotic scanner may be used for such scheduling. For example, a UI on a handheld scanner may be caused to display instructions for the employee to move to a particular location once the current scanning is completed.

In some cases, the interrogator itself may have functionality to direct the employee to rescan an area. For example, if a person is standing behind a shelving unit that the employee is scanning, the interrogator may turn off scanning for a portion of time and an indicator on the interrogator, such as an audio, haptic or visual feedback mechanism, may indicate to the employee that the scan was unsuccessful. This may indicate that the employee needs to rescan the area.

In some cases, fixed tags, for example associated with the shelving unit, can be employed to verify that scanning of a certain area has occurred. For example, if a tag is part of a shelving unit, and if an interrogator has not received the code from the tag on such shelving unit for a threshold amount of time, this may indicate that the area needs to be scanned.

Thus, areas for which scanning was avoided or which were scanned with potential interference can be scheduled to be scanned at block 342.

From block 342 the process may proceed to block 320 to determine whether a new scan should be started.

Signalling

In some embodiments, the interrogation device and computing system may be self-contained in a single device. In other embodiments, the interrogation device may be part of the first computing system and may communicate with a second computing system, such as with the embodiment of FIG. 2.

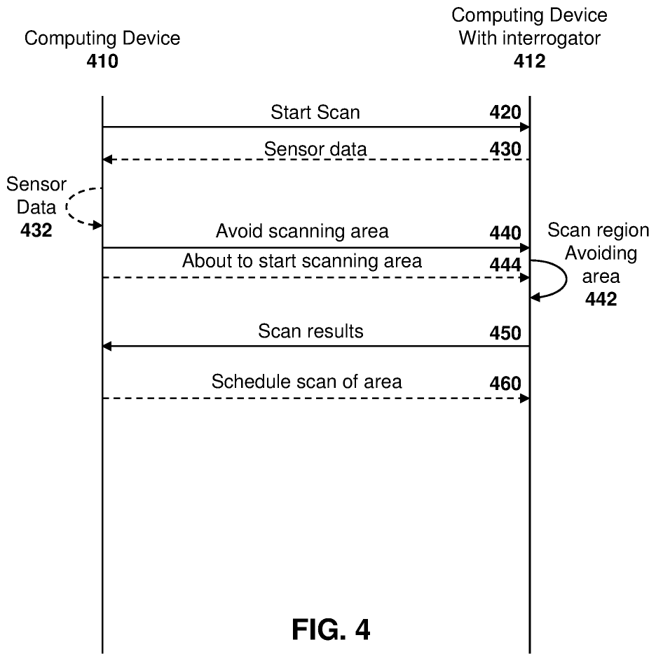

In this latter case, communication may exist between the first computing system and the second computing system. Reference is now made to FIG. 4.

In the embodiment of FIG. 4, device 410 may be a network server, store computing system, warehouse computing device, among other options.

In this embodiment, computing device with interrogator 412 may be a robotic interrogator unit, a handheld interrogator unit, or a device controlling interrogators, whether fixed or mobile, among other options.

In some cases, computing device 410 may request interrogator device 412 to start a scan, as shown with message 420. Message 420 may be sent as a result of a trigger condition being met, for example.

Sensor data or other data may optionally be provided from interrogator device 412 to computing device 410. Further, computing device 410 may receive sensor data as shown at arrow 432 from sensors associated with computing device 410.

Based on sensor data received in message 430 and/or sensor data received at arrow 432, computing device 410 may make a determination that an object exists within the scan area. In this regard, computing device 410 may send a message 440 to the interrogator device 412 to avoid scanning in a particular area.

The interrogator device may then start scanning the region, avoiding the area, as shown at arrow 442. During the scanning, computing device 410 may be providing indications of when the scanner is about to start scanning the area to be avoided, shown with messages 444.

Once the scanning is completed, the interrogator device 412 may send the scan results back to computing device 410, shown with message 450.

The computing device 410 may then optionally provide a schedule to scan an area that was previously avoided to the interrogator device 412, shown with message 460.

Based on the above, a computer system can use sensors other than an interrogator to detect objects in an area that is to be scanned, and avoid scanning such area. The areas in which the scanning was avoided may then be rescanned at a future time based on an event such as the object being moved away from the area, or based on a schedule to come back to the area.

While the embodiments above describe interrogators and secondary sensors as being distinct, in some embodiments the interrogators and secondary sensors may be part of the same physical component. The present disclosure is thus not limited to any particular configuration for the interrogators and the secondary sensors.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A method at a computing system comprising:
starting a scan of a region using an interrogator, the region including more than one area to be scanned;
detecting that an object exists within an area of the region; and
performing the scan of the region while avoiding scanning the area in which the object exists.

2. The method of claim 1, wherein the object is a person within the scan area.

3. The method of claim 1, wherein the avoiding comprises cancelling the scan.

4. The method of claim 1, wherein the avoiding comprises disabling the interrogator when the interrogator is pointed at the object.

5. The method of claim 1, wherein the avoiding comprises applying radio directionality to the interrogator to avoid the object.

6. The method of claim 1, wherein the detecting that the object exists within the area of the region comprises:
identifying the object as a particular person;
finding a history of exposure by the person to scans by one or more interrogators; and
determining that the exposure by the particular person within a timeframe exceeds a threshold.

7. The method of claim 1 further comprising scheduling a later scan of the area which was avoided.

8. The method of claim 7, wherein the scheduling the later scan comprises waiting until the object moves from the area which scanning was avoided.

9. The method of claim 7, wherein the scheduling the later scan comprises directing the interrogator to be moved back to the area in which scanning was avoided.

10. The method of claim 1, wherein the scan is a scan for Radio Frequency Identification (RFID) devices and the interrogator is a RFID interrogator for inventory control.

11. A computing system comprising:
at least one interrogator;
a processor; and
a communications subsystem,
wherein the computing system is configured to:
start a scan of a region using the at least one interrogator, the region including more than one area to be scanned;
detect that an object exists within an area of the region; and
perform the scan of the region while avoiding scanning the area in which the object exists.

12. The computing system of claim 11, wherein the object is a person within the scan area.

13. The computing system of claim 11, wherein the avoiding comprises cancelling the scan.

14. The computing system of claim 11, wherein the avoiding comprises disabling the interrogator when the interrogator is pointed at the object.

15. The computing system of claim 11, wherein the avoiding comprises applying radio directionality to the interrogator to avoid scanning the object.

16. The computing system of claim 11, wherein the computing system is configured to detect that the object exists within the area of the region by:
identifying the object as a particular person;
finding a history of exposure by the person to scans by one or more interrogators; and
determining that the exposure by the particular person within a timeframe exceeds a threshold.

17. The computing system of claim 11, wherein the computing system is further configured to schedule a later scan of the area which was avoided.

18. The computing system of claim 17, wherein the computing system is configured to schedule the later scan by waiting until the object moves from the area which scanning was avoided.

19. The computing system of claim 17, wherein the computing system is configured to schedule the later scan by directing the interrogator to be moved back to the area in which scanning was avoided.

20. A non-transitory computer-readable medium for storing instruction code, which, when executed by a processor of a computing system having at least one interrogator cause the computing system to:
start a scan of a region using the at least one interrogator, the region including more than one area to be scanned;
detect that an object exists within an area of the region; and
perform the scan of the region while avoiding scanning the area in which the object exists.
